(19) United States
(12) Patent Application Publication
(10) Pub. No.: US 2026/0278217 A1
(43) Pub. Date: Sep. 17, 2026

(54) MACHINE LEARNING CONNECTOR DESIGN ASSISTANCE

(71) Applicant: Molex, LLC, Lisle, IL (US)

(72) Inventors: Taolue Zhang, Naperville, IL (US); Peerouz Amleshi, Lisle, IL (US); Xiao Wu, Naperville, IL (US)

(21) Appl. No.: 19/469,396

(22) PCT Filed: Nov. 8, 2024
(86) PCT No.: PCT/IB2024/061073

§ 371 Date: Sep. 26, 2025

Related U.S. Application Data
(60) Provisional application No. 63/606,100, filed on Dec. 5, 2023.

(51) Int. Cl. G06F 30/27; G06F 30/23

(52) U.S. Cl. CPC G06F 30/27; G06F 30/23

(57) ABSTRACT

Disclosed are various embodiments for machine learning-and artificial intelligence-based connector design and assistance. At least one computing device is directed to access a computer-generated model of an input/output (I/O) connector having a housing and at least one conductive connector, direct execution of at least one machine learning model using the computer-generated model of the I/O connector or data derived therefrom to perform a finite element analysis (FEA) that generates structural results and a signal integrity (SI) analysis that generates signal integrity results. The at least one computing device determines at least one changed design parameter as a function of at least one of the signal integrity results and the structural results and directs display of at least one user interface comprising the at least one changed design parameter. The computer-generated model can be generated and optimized automatically without human intervention.

### BACKGROUND

A range of input/output (I/O) connectors are designed by engineers for power, data, and power and data interconnect systems, including board-to-board, wire-to-wire, and wire-to-board systems. A variety of designs exist for each type of system, depending on the requirements of the power and data communications environment in which the connectors are used. For high data rate applications in which physical space is constrained, as one example, it can be challenging to design interconnection system connectors due to a number of competing concerns. High data rate interconnection systems often rely upon differentially coupled signal pairs in which two conductors are arranged in a pair to transmit a differential signal. It is often difficult to design I/O connectors to meet competing concerns, such as signal integrity, compact size, rigid form factors, and so forth.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic diagram showing an example process in which an I/O connector is designed and refined until a suitable connector design is manually determined.

FIG. 2 is an example of a networked environment for machine learning connector design assistance according to various embodiments of the present disclosure.

FIG. 3 is a pictorial diagram of an example user interface rendered by a client device in the networked environment of FIG. 2 according to various embodiments of the present disclosure.

FIG. 4 is a flowchart illustrating one example of functionality implemented as portions of an artificial intelligence analysis engine executed in a computing environment in the networked environment of FIG. 2 according to various embodiments of the present disclosure.

FIG. 5 is a terminal of an I/O connector according to various embodiments of the present disclosure.

FIG. 6 is a table showing analysis results generated for the terminal of FIG. 5 according to various embodiments of the present disclosure.

FIGS. 7 and 8 are schematic diagrams illustrating terminals of an I/O connector in communication with conductive pads, associated constraints, and optimizable parameters thereof according to various embodiments of the present disclosure.

FIG. 9 is a schematic block diagram that provides one example illustration of a computing environment employed in the networked environment of FIG. 2 according to various embodiments of the present disclosure.

### DETAILED DESCRIPTION

The present disclosure relates to machine learning-and artificial intelligence-based connector design and assistance. As noted above, a variety of designs exist for each type of connector, generally depending on the requirements of the power and data communications environment in which the connectors are used. It is often difficult to design input/output (I/O) connectors to meet competing concerns, such as signal integrity, compact size, rigid form factors, and so forth.

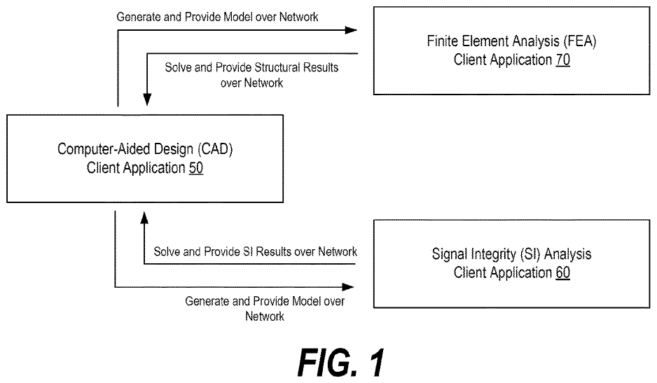

Referring to FIG. 1, in order to design an I/O connector having satisfactory signal integrity, a compact size, and one that satisfies various performance characteristics, engineers often utilize various software applications, such as a computer-aided design (CAD) client application 50. The CAD client application 50 is utilized to generate two-dimensional or three-dimensional models of an I/O connector and associated data. For instance, a design engineer in a first location utilizes the CAD client application 50 to generate a model of an I/O connector, which is then transmitted over a network to a signal integrity (SI) engineer in a second location who utilizes a SI client application 60 to perform a signal integrity analysis on the model. The results of the signal integrity analysis are then reverted back to the design engineer to make changes.

Then, the design engineer transmits the updated model over the network to a finite element analysis (FEA) engineer in a third location who utilizes an FEA client application 70 to perform an FEA analysis on the model. The results of the FEA analysis are then reverted back to the design engineer to make further changes. This operation continues or, in other words, the models are reverted among multiple locations and engineers continuously, until the FEA results are satisfactory, the SI results are satisfactory, and all design constraints and conditions are satisfied.

The transmission of the model, generally being one or more very large files, utilizes substantial network resources and impairs network bandwidth. Compressing the models prior to transmission utilizes additional central processing unit (CPU) time and additional memory. The storage of the models for use in one or more client applications utilizes local memory and local network resources. Moreover, in some instances, signal integrity optimalization may not produce manufacturable geometries of an I/O connector.

Accordingly, in various embodiments, a local-or cloud-based application is described that performs at least one of signal integrity analysis and mechanical performance analysis as a two-dimensional or three-dimensional model of an I/O connector is designed. In some embodiments, a system is described that includes at least one computing device directed to access a computer-generated model of an I/O connector having a housing and at least one conductive connector (e.g., a terminal). Execution of at least one machine learning model is directed using the computer-generated model of the I/O connector or data derived therefrom, where the at least one machine learning model is adapted to perform at least one of a finite element analysis that generates structural results and a signal integrity analysis that generates signal integrity results. One or more changed design parameters are determined as a function of at least one of the signal integrity results and the structural results, and at least one user interface is generated and display that includes the changed design parameters. The computer-generated model of the I/O connector can further include one or more of a board interface, a mating interface, a leadframe, and a U-shield, among other components, as can be appreciated.

In some embodiments, execution of the at least one machine learning model includes directing execution of a first machine learning model using the computer-generated model of the I/O connector or the data derived therefrom to perform the finite element analysis that generates the structural results, and directing execution of a second machine learning model using the computer-generated model of the I/O connector or the data derived therefrom to perform the signal integrity analysis that generates the signal integrity results.

The changed design parameters can be determined as a function of the at least one of the signal integrity results, the structural results, and, in some embodiments, an optimization routine. The optimization routine can include one or more of a downhill simplex routine, a multi-objective particle swarm routine, a pointer routine, a polynomial regression routine, a moving least squares routine, and a deep feedforward network routine. The optimization routine can reduce computational complexity of various analyses, which can improve speed of generating a changed design parameter and utilize less computing resources (e.g., less memory, CPU time, and so forth).

In some embodiments, the changed design parameters are selected to optimize signal integrity of an I/O connector. For instance, a signal integrity parameter of an I/O connector as optimized can include one or more of a differential insertion loss parameter, a common mode (CM) insertion loss parameter, a return loss parameter, a time-domain reflectometry (TDR) parameter, a near-end crosstalk (NEXT) parameter, a far-end crosstalk (FEXT) parameter, a mode conversion parameter, an insertion loss deviation (ILD) parameter, an integrated crosstalk noise (ICN) parameter, a channel operating margin (COM) parameter, and an electromagnetic interference (EMI) parameter.

Further, the changed design parameters can be selected to optimize a mechanical component of the I/O connector. For example, a mechanical parameter of the I/O parameter as optimized can include one or more of a contact normal force parameter, a contact permanent set parameter, a minimum contact insertion force parameter, a maximum contact retention force parameter, a contact degree of independence parameter, a maximum angular mating parameter, a maximum over-mating parameter, a minimum under-mating parameter, a minimum-maximum offset mating parameter, a maximum wafer lean parameter, and a wafer movement upon mating parameter.

The changed design parameters can be determined and selected based at least in part on a predefined constraint. The predefined constraint can include one or more of a physical envelope constraint, a maximum metal thickness constraint, a minimum metal thickness constraint, a minimum metal width constraint, a maximum metal edge-to-edge gap constraint, a pair-to-pair pitch constraint, a minimum wipe constraint, a minimum signal to shield gap constraint, a minimum plastic wall thickness constraint, a minimum contact lead-in constraint, and a minimum contact angle constraint. It is understood that further types of constraints can be employed.

The user interface as generated and displayed can include the changed design parameters, where the user interface can be that of a computer-aided design client application executable on at least one computing device. In some embodiments, the user interface can include an artificial intelligence dialog in which free-text user inputs can be defined, mimicking a conversation between the user and an artificial intelligence service that optimizes the design of the I/O connector. Thus, the artificial intelligence dialog can include the changed design parameter(s) in text-based or visual-based formats, among other information.

In the following discussion, a general description of the system and its components is provided, followed by a discussion of the operation of the same.

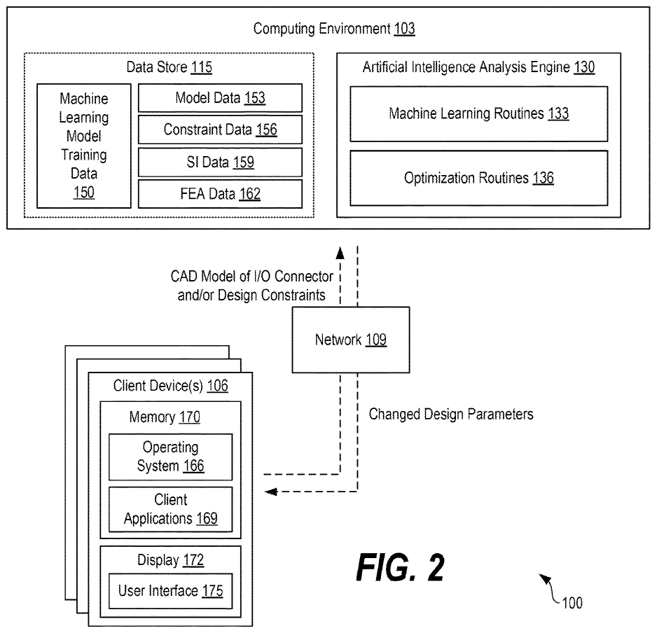

With reference to FIG. 2, a networked environment 100 is shown according to various embodiments. The networked environment 100 includes a computing environment 103 and a client device 106, which are in data communication with each other via a network 109. The network 109 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 103 can include, for example, a server computer or any other system providing computing capability. Alternatively, the computing environment 103 can employ a plurality of computing devices that may be arranged, for example, in one or more server banks or computer banks or other arrangements. Such computing devices can be located in a single installation or can be distributed among many different geographical locations. For example, the computing environment 103 can include a plurality of computing devices that together may comprise a hosted computing resource, a grid computing resource, and/or any other distributed computing arrangement. In some cases, the computing environment 103 can correspond to an elastic computing resource where the allotted capacity of processing, network, storage, or other computing-related resources may vary over time.

Various applications and/or other functionality can be executed in the computing environment 103 according to various embodiments. Also, various data is stored in a data store 115 that is accessible to the computing environment 103. The data store 115 can be representative of a plurality of data stores 115 as can be appreciated. The data stored in the data store 115, for example, is associated with the operation of the various applications and/or functional entities described below.

The components executed on the computing environment 103, for example, include an artificial intelligence analysis engine 130, machine learning routines 133, optimization routines 136, and other applications, services, processes, systems, engines, or functionality not discussed in detail herein. The artificial intelligence analysis engine 130 is generally executed to access a computer-generated design of an I/O connector, perform various analyses of the I/O connector, determine whether the I/O connector complies with various criteria and constraints, and, if the I/O connector does not comply with the various criteria and constraints, generate changed design parameters that, if implemented, cause the I/O connector to comply with the various criteria and constraints.

In various embodiments, the artificial intelligence analysis engine 130 directs execution of one or more machine learning routines 133. The machine learning routines 133 can be executed to perform signal integrity analysis, finite element analysis, among other types of analyses in order to determine whether a design of an I/O connector satisfies various design constraints. Moreover, in some embodiments, the artificial intelligence analysis engine 130 can direct execution of various optimization routines 136. As can be appreciated, for a limited range of variables, traditional cost function optimization may not be possible. For some problems, collecting sufficient data along the trajectory of can require long execution times and use a considerable amount of computing resources (e.g., memory, CPU resources, and so forth).

Thus, the optimization routines 136, implementing various artificial intelligence routines, can optimize solutions using less data, thereby reducing computing time and utilizing less computational resources. The optimization routines 136 thus can include one or more of optimization machine learning routines, regression analysis routines (e.g., supervised routines), principal component analysis routines (e.g., unsupervised routines), deep-learning routines (e.g., neural network routines) of varying architectural types and configurations, and so forth.

The data stored in the data store 115 includes, for example, machine learning model training data 150, model data 153, constraint data 156, signal integrity data 159, finite element analysis data 162, and potentially other data. The machine learning model training data 150 can include data used to train a machine learning routine 133, implementing a particular type of machine learning model, to generate SI results, generate FEA results, or a combination thereof. In some embodiments, the machine learning model training data 150 is manually curated and improved using supervised machine learning. The model data 153 can include computer-generated design models that are automatically generated by the computing environment 103 or manually generated by the client device 106 (e.g., a model generated by a design engineer) and sent to the computing environment 103 over the network 109. For instance, the model data 153 can include CAD files, whether corresponding to two-dimensional or three-dimensional models of an I/O connector.

The constraint data 156 can include predefined constraints for an I/O connector, which can be application-specific constraints, SI constraint, FEA constraints, and so forth. SI data 159 can include signal integrity analysis results generated by one or more of the machine learning routines 133 or the optimization routines 136. Similarly, FEA data 162 can include FEA analysis results generated by one or more of the machine learning routines 133 or the optimization routines 136, as will be described.

The client device 106 is representative of a plurality of client devices that may be coupled to the network 109. The client device 106 can include, for example, a processor-based system such as a computer system. Such a computer system can be embodied in the form of a desktop computer, a laptop computer, personal digital assistants, cellular telephones, smartphones, set-top boxes, music players, web pads, tablet computer systems, game consoles, electronic book readers, or other devices with like capability. The client device 106 may include a display 172. The display 172 can include, for example, one or more devices such as liquid crystal display (LCD) displays, gas plasma-based flat panel displays, organic light emitting diode (OLED) displays, electrophoretic ink (E-ink) displays, LCD projectors, or other types of display devices, etc.

The client device 106 can be configured to execute various applications such as an operating system 166, a client application 169, and/or other applications stored in memory 170. The client application 169 can be executed in a client device 106, for example, to access network content served up by the computing environment 103 and/or other servers, thereby rendering a user interface 175 on the display 172. To this end, the client application 169 can comprise, for example, a browser, a dedicated application, the client applications 50, 60, and/or 70 described above with respect to FIG. 1, etc., and the user interface 175 can include a network page, an application screen, etc. The client device 106 can be configured to execute applications beyond the client application 169 such as, for example, email applications, social networking applications, word processors, spreadsheets, and/or other applications.

Next, a general description of the operation of the various components of the networked environment 100 is provided. To begin, a design engineer, utilizing a client device 106, can generate a computer-generated model of an I/O connector, for instance, utilizing a CAD client application 50 (or other similar client application 169). The I/O connector can include one or more of a housing, terminals, a board interface, a mating interface, a leadframe, a U-shield, among other known I/O connector components.

The computing environment 103 can access the computer-generated model of the I/O connector, which can be sent over the network 109. Thereafter, the computing environment 103 can direct execution of at least one machine learning routine 133 using the I/O connector or data derived therefrom to perform at least one of a finite element analysis that generates structural results and a SI analysis that generates signal integrity results. The machine learning routines 133 can include those trained with machine learning model training data 150, as can be appreciated.

Prior, after, or concurrently with execution of the machine learning routines 133, the artificial intelligence analysis engine 130 can execute one or more optimization routines 136 that reduce the computational complexity of the connector optimization, thereby using less computational resources and increasing the speed of computation. Ultimately, a changed design parameter can be determined by the machine learning routines 133 as a function of the signal integrity results and/or the structural results. A user interface 175 having the changed design parameter can be displayed on the client device 106. The changed design parameter can include an alteration of a design parameter of the I/O connector as originally provided to the artificial intelligence analysis engine 130.

In some embodiments, executing the machine learning routines 133 can include executing a first machine learning routine 133 to perform the finite element analysis that generates the structural results, and executing a second machine learning routine 133 (different from the first machine learning routine 133) to perform the signal integrity analysis that generates the signal integrity results. In some embodiments, however, a single machine learning routine 133 can be executed to perform both FEA and SI analyses.

In some implementations, the changed design parameter can be determined as a function of the signal integrity results, the structural results, and an optimization routine 136. The optimization routine 136 can include one or more of a downhill simplex routine, a multi-objective particle swarm routine, a pointer routine, a polynomial regression routine, a moving least squares routine, and a deep feedforward network routine, among other types of optimization routines.

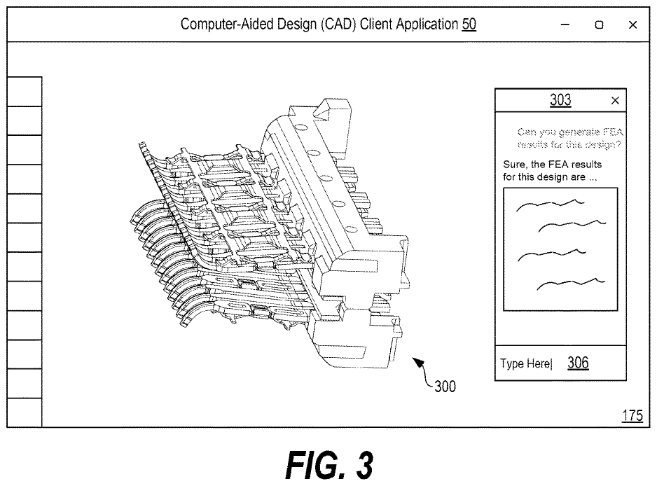

The computing environment 103 and/or the client application 169 on the client device 103 can display a user interface 175. The user interface 175 can include the at least one changed design parameter, where the user interface 175, in some embodiments, is that of a CAD client application 50 executable on the client device 106, as shown in FIG. 3.

Referring to FIG. 3, a user interface 175 is shown illustrating an example of a CAD client application 50. The user interface 175, and the components shown therein, can be used to create a three-dimensional or two-dimensional model of an I/O connector 300, as can be appreciated. For instance, the CAD client application 50 can be manipulated to create an I/O connector 300 having a number of terminals, a housing, wires, leadframes, and other connector components.

In some embodiments, the user interface 175 can include an artificial intelligence dialog 303 in which free-text user prompts 306 can be defined. For instance, a user can type “Can you generate FEA results for this design?” Alternatively, the user can type, for example, “With the constrains and targets provided, can you design a connector with the best-defined signal integrity performance?” It is understood that various text recognition routines, such as a large language model (LLM), can be executed to derive meaning of a free-text instruction and the meaning can thus be used to generate a result to be provided in the dialog 303 or other suitable portion of the user interface 175. In reply to the question issued by the user, the artificial intelligence analysis engine 130 can perform an FEA analysis and return relevant results. While shown in the dialog 303, it is understood that overlays, icons, or other features can be rendered in association with the I/O connector 300 to provide an intuitive approach to showing FEA results, SI results, or other analyses result. Thus, the artificial intelligence dialog 303 can include the changed design parameter, among other information.

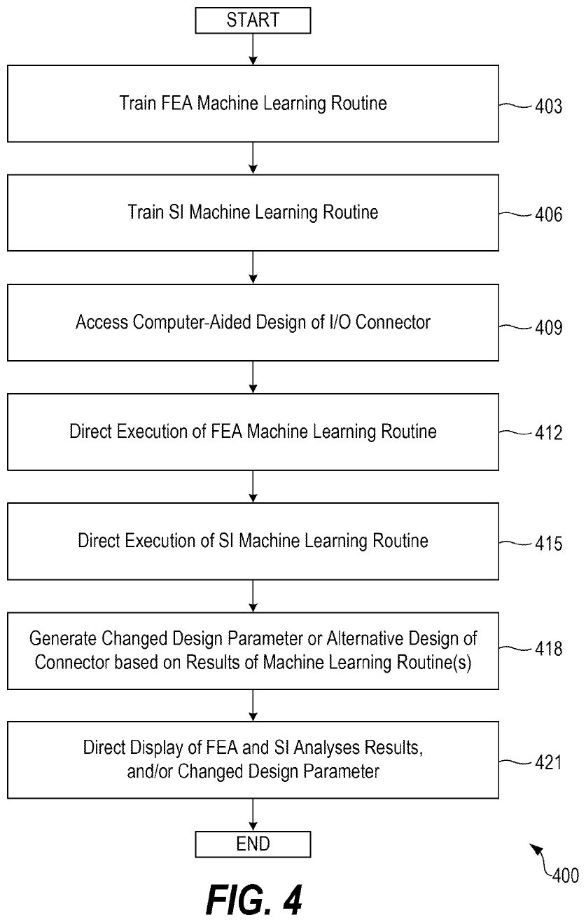

Referring next to FIG. 4, shown is a flowchart 400 that provides one example of the operation of a portion of the artificial intelligence analysis engine 130 according to various embodiments. It is understood that the flowchart of FIG. 4 provides merely an example of the many different types of functional arrangements that may be employed to implement the operation of the portion of the artificial intelligence analysis engine 130 and/or a CAD client application 50 as described herein. As an alternative, the flowchart of FIG. 4 may be viewed as depicting an example of elements of a method implemented in the computing environment 103 and/or a client device 106 according to one or more embodiments.

Beginning with box 403, a machine learning routine 133 is trained with machine learning model training data 150 to generate an FEA machine learning model for performing FEA analysis. The training data 150 can thus include, for example, prior data on design parameters and associated FEA results. Similarly, at box 406, a machine learning routine 133 is trained with machine learning model training data 150 to generate a SI machine learning model for performing SI analysis. The training data 150 can thus further include, for example, prior data on design parameters and associated SI results. While, for purposes explanation, two separate machine learning routines 133 are described, it is understood that a single machine learning routine 133 can be trained and executed to perform FEA and SI analyses simultaneously.

Next, at box 409, a computer-generated model of an I/O connector 300 (e.g., having a housing and at least one conductive connector) is accessed. In some embodiments, the CAD model of the I/O connector 300 is manually generated by a human using a CAD client application 50. In other embodiments, however, the computing environment 103 may generate an I/O connector having a rough geometry that can be continuously modified and optimized based on various constraints received from the client device 106 or otherwise defined.

At box 412, execution of at least one machine learning routine 133 can be directed using the computer-generated model of the I/O connector 300, or data derived therefrom, to perform at least one of a finite element analysis that generates structural results. Likewise, at box 415, execution of at least one machine learning routine 133 can be directed using the computer-generated model of the I/O connector 300, or data derived therefrom, to perform at least one of an SI analysis that generates SI results.

At box 418, a changed design parameter can be determined by the computing environment 103 as a function of at least one of the signal integrity results and the structural results. In some embodiments, the I/O connector 300 can be automatically adjusted (e.g., without human intervention) using the changed design parameter. Further, in some embodiments, the changed design parameter can be determined as a function of at least one of the signal integrity results, the structural results, and an optimization routine. The optimization routine can include one or more of a downhill simplex routine, a multi-objective particle swarm routine, a pointer routine, a polynomial regression routine, a moving least squares routine, and a deep feedforward network routine.

In some embodiments, the changed design parameter can be selected to optimize a signal integrity parameter. The signal integrity parameter can include one or more of a differential insertion loss parameter, a common mode insertion loss parameter, a return loss parameter, a time-domain reflectometry parameter, a near-end crosstalk parameter, a far-end crosstalk parameter, a mode conversion parameter, an insertion loss deviation parameter, an integrated crosstalk noise parameter, a channel operating margin parameter, and an electromagnetic interference parameter.

Further, the changed design parameter can be selected to optimize a mechanical parameter. The mechanical parameter can include one or more of a contact normal force parameter, a contact permanent set parameter, a minimum contact insertion force parameter, a maximum contact retention force parameter, a contact degree of independence parameter, a maximum angular mating parameter, a maximum over-mating parameter, a minimum under-mating parameter, a minimum-maximum offset mating parameter, a maximum wafer lean parameter, and a wafer movement upon mating parameter.

In some implementations, the changed design parameter can be selected based at least in part on a predefined constraint. The predefined constraint can include one or more of a physical envelope constraint, a maximum metal thickness constraint, a minimum metal thickness constraint, a minimum metal width constraint, a maximum metal edge-to-edge gap constraint, a pair-to-pair pitch constraint, a minimum wipe constraint, a minimum signal to shield gap constraint, a minimum plastic wall thickness constraint, a minimum contact lead-in constraint, and a minimum contact angle constraint.

At box 421, the computing environment 103 can direct display of at least one user interface 175 comprising the changed design parameter, the FEA and SI analyses results, and/or the model of the I/O connector 300 as modified or adjusted. In other words, the user interface 175 can include the changed design parameter, where the user interface 175 can be that of a CAD client application 50 executable on the client device 106 or other computing device. The user interface 175 can include an artificial intelligence dialog 303 in which free-text user prompts 306 can be specified, as described above with respect to FIG. 3. Thus, the artificial intelligence dialog 303 can include the changed design parameter, among other information in some implementations.

Mathematically, with reference to a three-dimensional model of an I/O connector 300, an n-Variable surface can be defined as f(x1, x2, . . . , xn) which can represent the effect of independent variables in a function value. For instance, a surface temperature of a sphere can be presented as T(x1, x2), where x1 and x2 are latitude and longitude. In a sphere temperature analysis, a three-dimensional heat map or contour plot can be produced as temperature data at various locations are obtained. This can be modeled, represented, visualized, and understood.

Since temperature can also be a function of time, this function can be expanded to a three-variable function, T(x1, x2, x3), where x3 represents the time at a time reference point. This can be difficult to graphically represent and visualize, as it could require four dimensions. As such, for optimization of an I/O connector 300, the computing environment 103 can assign several dimensions (e.g., n=100). In this case of the temperature of the sphere, as more data is collected, the temperature can be analyzed and mapped more accurately; however, this data cannot be used to optimize temperature as temperature is not adjustable in some cases.

Given T(x1, x2, x3), there are routines, analytically and in closed forms, that can determine minima/maxima (global Max/Min), or constrain the geography, and find Max/Min temperature within a predetermined region. For example, for a surface function, La Grange Multipliers can be applied to find such maximum and minimum points for sets of constrains by solving the set of equation: ∇\hat{ } T(X_i)=λ∇G(X_i) and G(X_i)=0, where λ is a multiplier and G(X_i)=0 is the constrain function.

For optimization, the behavior of the system to a f(x1, x2, . . . , xn) can be modeled. Then, the solution is understandable if the function is continuous and bounded. However, defining such a function may not be possible by obtaining a finite number of samples. For different applications, some routines may be more suitable. Some of common issues with optimization include solution convergence; local minimum/maximum traps; nonlinearities; complexity of multi-objective nature of some problems in I/O connector design; and a substantial increase in a solution time for a large n value.

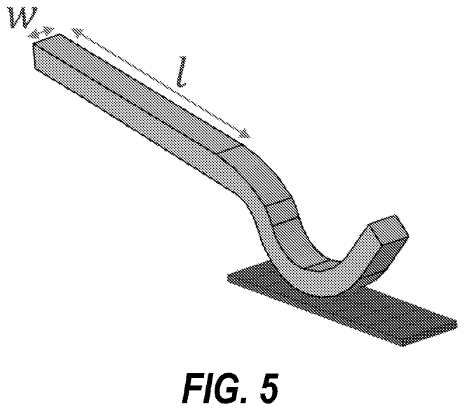

With reference to FIG. 5, a portion of an I/O connector 300 is shown as a three-dimensional model representation, which can be generated using a CAD client application 50, for example. The portion includes a terminal of an I/O connector 300 that can contact a corresponding terminal, a conductive pad, or like device. The terminal has a width W and a length L. The computing environment 103 can optimize the width W and the length L of the I/O connector 300, among other parameters, based on various constraints provided to the computing environment 103 (e.g., by the design engineer or based on other predefined constraints).

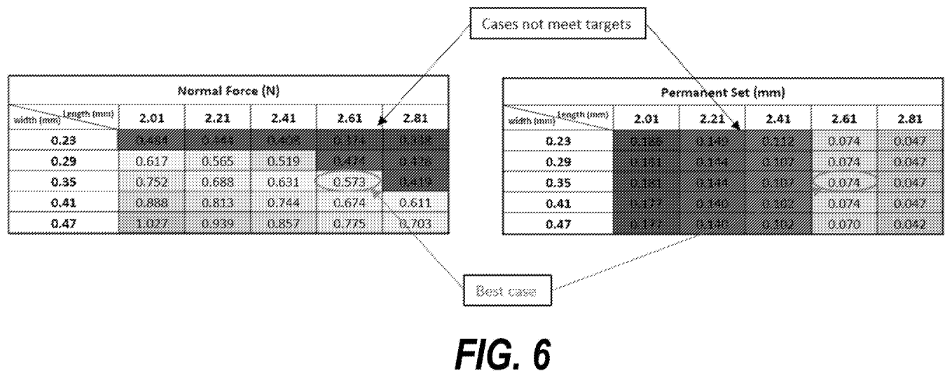

Machine learning model results that were manually generated are shown in table form in FIG. 6. Specifically, twenty-five potential modifications of the terminal were analyzed (e.g., various combinations of 5 different widths and 5 different lengths). The case with the least volume can be determined as the most optimal design based on an analysis of normal force (N) and a permanent set (mm). Results that do not meet various design constraints can be excluded from the optimal results.

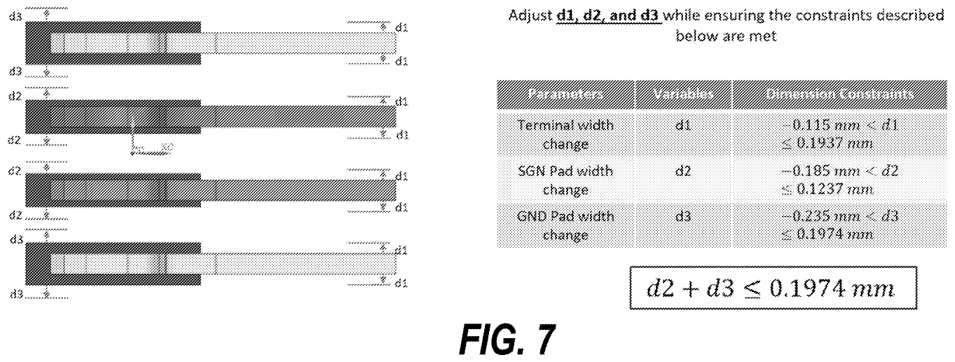

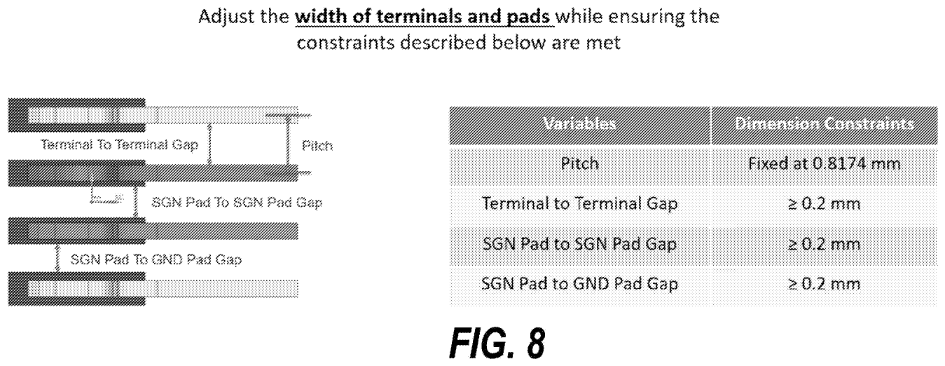

FIGS. 7 and 8 are schematic diagrams illustrating a multitude of terminals in communication with conductive pads and associated constraints according to various embodiments of the present disclosure. Specifically, a table is shown in FIGS. 7 and 8, respectively, having various dimension constraints for a terminal of an I/O connector 300 as well as a conductive pad in communication therewith. A terminal width change parameter d1, a SGN pad width change parameter d2, and GND pad width change parameter d3 are adjustable with respect to FIG. 7, whereas a pitch parameter, a terminal to terminal gap parameter, a SGN pad to SGN pad gap parameter, and a SGN pad to GND pad gap parameter are adjustable with respect to FIG. 8. These parameters can be determined by the artificial intelligence analysis engine 130 such that signal interference results are optimized, thereby generating one or more changed design parameters to implement to improve SI performance.

In various embodiments, a changed design parameter can be determined concurrently or simultaneously with an SI and FEA analysis by the artificial intelligence analysis engine 130 such that a changed design parameter improves both FEA and SI performance as compared to the originally analyzed model of the I/O connector 300.

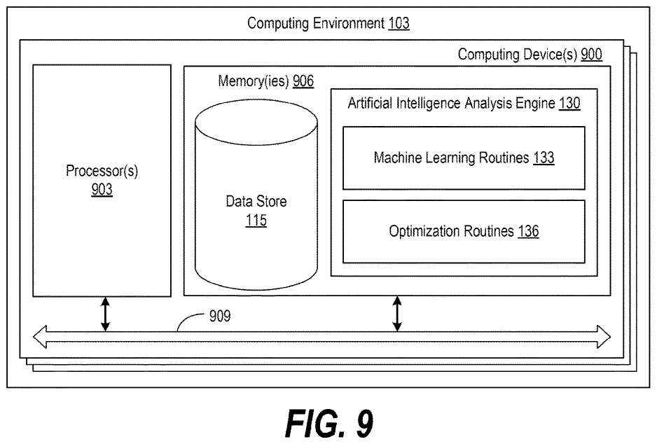

With reference to FIG. 9, shown is a schematic block diagram of the computing environment 103 according to an embodiment of the present disclosure. The computing environment 103 includes one or more computing devices 900. Each computing device 900 includes at least one processor circuit, for example, having a processor 903 and a memory 906, both of which are coupled to a local interface 909. To this end, each computing device 900 may comprise, for example, at least one server computer or like device. The local interface 909 may comprise, for example, a data bus with an accompanying address/control bus or other bus structure as can be appreciated.

Stored in the memory 906 are both data and several components that are executable by the processor 903. In particular, stored in the memory 906 and executable by the processor 903 are the artificial intelligence analysis engine 130, the machine learning routines 133, the optimization routines 136, and potentially other applications. Also stored in the memory 906 may be a data store 115 and other data. In addition, an operating system may be stored in the memory 906 and executable by the processor 903.

It is understood that there may be other applications that are stored in the memory 906 and are executable by the processor 903 as can be appreciated. Where any component discussed herein is implemented in the form of software, any one of a number of programming languages may be employed such as, for example, C, C++, C #, Objective C, Java®, JavaScript®, Perl, PHP, Visual Basic®, Python®, Ruby, Flash®, or other programming languages.

A number of software components are stored in the memory 906 and are executable by the processor 903. In this respect, the term “executable” means a program file that is in a form that can ultimately be run by the processor 903. Examples of executable programs may be, for example, a compiled program that can be translated into machine code in a format that can be loaded into a random access portion of the memory 906 and run by the processor 903, source code that may be expressed in proper format such as object code that is capable of being loaded into a random access portion of the memory 906 and executed by the processor 903, or source code that may be interpreted by another executable program to generate instructions in a random access portion of the memory 906 to be executed by the processor 903, etc. An executable program may be stored in any portion or component of the memory 906 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 906 is defined herein as including both volatile and nonvolatile memory and data storage components. Volatile components are those that do not retain data values upon loss of power. Nonvolatile components are those that retain data upon a loss of power. Thus, the memory 906 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 903 may represent multiple processors 903 and/or multiple processor cores and the memory 906 may represent multiple memories 906 that operate in parallel processing circuits, respectively. In such a case, the local interface 909 may be an appropriate network that facilitates communication between any two of the multiple processors 903, between any processor 903 and any of the memories 906, or between any two of the memories 906, etc. The local interface 909 may comprise additional systems designed to coordinate this communication, including, for example, performing load balancing. The processor 903 may be of electrical or of some other available construction.

Although the artificial intelligence analysis engine 130, the machine learning routines 133, the optimization routines 136, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart 400 of FIG. 4 shows the functionality and operation of an implementation of portions of the artificial intelligence analysis engine 130. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 903 in a computer system or other system. The machine code may be converted from the source code, etc. If embodied in hardware, each block may represent a circuit or a number of interconnected circuits to implement the specified logical function(s).

Although the flowchart 400 of FIG. 4 shows a specific order of execution, it is understood that the order of execution may differ from that which is depicted. For example, the order of execution of two or more blocks may be scrambled relative to the order shown. Also, two or more blocks shown in succession in FIG. 4 may be executed concurrently or with partial concurrence. Further, in some embodiments, one or more of the blocks shown in FIG. 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the artificial intelligence analysis engine 130, the machine learning routines 133, and the optimization routines 136, that comprises software or code can be embodied in any non-transitory computer-readable medium for use by or in connection with an instruction execution system such as, for example, a processor 903 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the artificial intelligence analysis engine 130, the machine learning routines 133, and the optimization routines 136, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 900, or in multiple computing devices in the same computing environment 103. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A system, comprising:
at least one computing device having memory; and
program instructions stored in the memory that, when executed by the at least one computing device, direct the at least one computing device to:
access a computer-generated model of an input/output (I/O) connector, the computer-generated model of the I/O connector having a housing and at least one conductive connector;
direct execution of at least one machine learning model using the computer-generated model of the I/O connector or data derived therefrom, the at least one machine learning model adapted to perform a finite element analysis (FEA) that generates structural results and a signal integrity (SI) analysis that generates signal integrity results;
determine at least one changed design parameter as a function of at least one of the signal integrity results and the structural results; and
direct display of at least one user interface comprising the at least one changed design parameter.

2. The system of claim 1, wherein execution of the at least one machine learning model using the computer-generated model of the I/O connector or data derived therefrom is directed by:
directing execution of a first machine learning model using the computer-generated model of the I/O connector or the data derived therefrom to perform the finite element analysis that generates the structural results; and
directing execution of a second machine learning model using the computer-generated model of the I/O connector or the data derived therefrom to perform the signal integrity analysis that generates the signal integrity results.

3. The system of claim 1, wherein the at least one changed design parameter determined as a function of the at least one of the signal integrity results, the structural results, and an optimization routine.

4. The system of claim 3, wherein the optimization routine is selected from a group consisting of: a downhill simplex routine; a multi-objective particle swarm routine; a pointer routine; a polynomial regression routine; a moving least squares routine; and a deep feedforward network routine.

5. The system of claim 1, wherein the at least one changed design parameter is selected to optimize a signal integrity parameter, the signal integrity parameter selected from a group consisting of:
a differential insertion loss parameter; a common mode (CM) insertion loss parameter; a return loss parameter; a time-domain reflectometry (TDR) parameter; a near-end crosstalk (NEXT) parameter; a far-end crosstalk (FEXT) parameter; a mode conversion parameter; an insertion loss deviation (ILD) parameter; an integrated crosstalk noise (ICN) parameter; a channel operating margin (COM) parameter; and an electromagnetic interference (EMI) parameter.

6. The system of claim 1, wherein the at least one changed design parameter is selected to optimize a mechanical parameter, the mechanical parameter selected from a group consisting of:
a contact normal force parameter; a contact permanent set parameter; a minimum contact insertion force parameter; a maximum contact retention force parameter; a contact degree of independence parameter; a maximum angular mating parameter; a maximum over-mating parameter; a minimum under-mating parameter; a minimum-maximum offset mating parameter; a maximum wafer lean parameter; and a wafer movement upon mating parameter.

7. The system of claim 1, wherein the computer-generated model of the I/O connector further comprises at least one of: a board interface; a mating interface; a leadframe; and a U-shield.

8. The system of claim 1, wherein the at least one changed design parameter is selected based at least in part on a predefined constraint, the predefined constraint selected from a group consisting of:
a physical envelope constraint; a maximum metal thickness constraint; a minimum metal thickness constraint; a minimum metal width constraint; a maximum metal edge-to-edge gap constraint; a pair-to-pair pitch constraint; a minimum wipe constraint; a minimum signal to shield gap constraint; a minimum plastic wall thickness constraint; a minimum contact lead-in constraint; and a minimum contact angle constraint.

9. The system of claim 1, wherein the at least one user interface comprising the at least one changed design parameter is a user interface of a computer-aided design (CAD) client application executable on the at least one computing device, the user interface comprising an artificial intelligence dialog in which free-text user inputs can be defined, the artificial intelligence dialog comprising the at least one changed design parameter.

10. A computer-implemented method, comprising:
generating a computer-generated model of an input/output (I/O) connector without human intervention, the computer-generated model of the I/O connector having a housing and at least one conductive connector;
directing execution of at least one machine learning model using the computer-generated model of the I/O connector or data derived therefrom, the at least one machine learning model adapted to perform a finite element analysis (FEA) that generates structural results and a signal integrity (SI) analysis that generates signal integrity results;
determining at least one changed design parameter as a function of at least one of the signal integrity results and the structural results; and
adjusting the computer-generated model of the I/O connector without human intervention based on the at least one changed design parameter.

11. The method of claim 10, further comprising directing display of at least one user interface comprising the at least one changed design parameter or the computer-generated model as adjusted.

12. The method of claim 10, wherein the computer-generated model of the I/O connector is a predetermined I/O connector rough geometry.

13. The method of claim 10, wherein execution of the at least one machine learning model using the computer-generated model of the I/O connector or data derived therefrom is directed by:
directing execution of a first machine learning model using the computer-generated model of the I/O connector or the data derived therefrom to perform the finite element analysis that generates the structural results; and
directing execution of a second machine learning model using the computer-generated model of the I/O connector or the data derived therefrom to perform the signal integrity analysis that generates the signal integrity results.

14. The method of claim 10, wherein the at least one changed design parameter determined as a function of the at least one of the signal integrity results, the structural results, and an optimization routine.

15. The method of claim 14, wherein the optimization routine is selected from a group consisting of: a downhill simplex routine; a multi-objective particle swarm routine; a pointer routine; a polynomial regression routine; a moving least squares routine; and a deep feedforward network routine.

16. The method of claim 10, wherein the at least one changed design parameter is selected to optimize a signal integrity parameter, the signal integrity parameter selected from a group consisting of:
a differential insertion loss parameter; a common mode (CM) insertion loss parameter; a return loss parameter; a time-domain reflectometry (TDR) parameter; a near-end crosstalk (NEXT) parameter; a far-end crosstalk (FEXT) parameter; a mode conversion parameter; an insertion loss deviation (ILD) parameter; an integrated crosstalk noise (ICN) parameter; a channel operating margin (COM) parameter; and an electromagnetic interference (EMI) parameter.

17. The method of claim 10, wherein the at least one changed design parameter is selected to optimize a mechanical parameter, the mechanical parameter selected from a group consisting of:
a contact normal force parameter; a contact permanent set parameter; a minimum contact insertion force parameter; a maximum contact retention force parameter; a contact degree of independence parameter; a maximum angular mating parameter; a maximum over-mating parameter; a minimum under-mating parameter; a minimum-maximum offset mating parameter; a maximum wafer lean parameter; and a wafer movement upon mating parameter.

18. The method of claim 10, wherein the computer-generated model of the I/O connector further comprises at least one of: a board interface; a mating interface; a leadframe; and a U-shield.

19. The method of claim 10, wherein the at least one changed design parameter is selected based at least in part on a predefined constraint, the predefined constraint selected from a group consisting of:
a physical envelope constraint; a maximum metal thickness constraint; a minimum metal thickness constraint; a minimum metal width constraint; a maximum metal edge-to-edge gap constraint; a pair-to-pair pitch constraint; a minimum wipe constraint; a minimum signal to shield gap constraint; a minimum plastic wall thickness constraint; a minimum contact lead-in constraint; and a minimum contact angle constraint.

20. The method of claim 10, wherein the at least one user interface comprising the at least one changed design parameter is a user interface of a computer-aided design (CAD) client application executable on at least one computing device, the user interface comprising an artificial intelligence dialog in which free-text user inputs can be defined, the artificial intelligence dialog comprising the at least one changed design parameter.
